(19) United States
(12) Patent Application Publication
(10) Pub. No.: US 2022/0129923 A1
(43) Pub. Date: Apr. 28, 2022

(54) DEEP LEARNING BASED BEHAVIOR CLASSIFICATION

(71) Applicant: International Business Machines Corporation, Armonk, NY (US)

(72) Inventors: Eugene Irving Kelton, Wake Forest, NC (US); Yi-Hui Ma, Mechanicsburg, PA (US); Willie Robert Patten, Jr., Hurdle Mills, NC (US); Brandon Harris, Union City, NJ (US)

(21) Appl. No.: 17/082,168

(22) Filed: Oct. 28, 2020

(51) Int. Cl. G06Q 30/02; G06N 20/00

(52) U.S. Cl. CPC G06Q 30/0202; G06N 20/00

(57) ABSTRACT

Embodiments of the present invention provide methods, computer program products, and systems. Embodiments of the present invention can, in response to receiving a request, dynamically determine variables associated with a transaction. Embodiments of the present invention can then generate a historical timeline for a respective target comprising images representing transactions affected by the dynamically determined variables. Embodiments of the present invention can then predict behavioral patterns of the respective target based on the generated historical time.

### BACKGROUND

The present invention relates generally to processing large machine learning datasets, and more particularly to classifying behavior through system generated timelines and deep learning.

Traditionally, machine learning refers to a study and construction of algorithms that can learn from and make predictions on data. These algorithms function by making data-driven predictions or decisions, through building a mathematical model from input data. The data used to build the final model usually comes from multiple datasets.

Major advances in this field can result from advances in learning algorithms (such as deep learning), computer hardware, and less-intuitively, the availability of high-quality training datasets. Deep learning part of a broader family of machine learning methods based on artificial neural networks with representation learning. Learning can be supervised, semi-supervised or unsupervised.

Deep learning architectures such as deep neural networks, deep belief networks, recurrent neural networks and convolutional neural networks have been applied to fields including computer vision, machine vision, speech recognition, natural language processing, audio recognition, social network filtering, machine translation, bioinformatics, drug design, medical image analysis, material inspection and board game programs, where they have produced results comparable to and in some cases surpassing human expert performance.

A timeline is a display of a list of events in chronological order. It is typically a graphic design showing a long bar labelled with dates paralleling it. Timelines can use any suitable scale representing time, suiting the subject and data. Many timelines use a linear scale, in which a unit of distance is equal to a set amount of time. This timescale is dependent on the events in the timeline.

### SUMMARY

According to an aspect of the present invention, there is provided a computer-implemented method. The method comprises in response to receiving a request, dynamically determining variables associated with a transaction; generating a historical timeline for a respective target comprising images representing transactions affected by the dynamically determined variables; and predicting behavioral patterns of the respective target based on the generated historical time.

### BRIEF DESCRIPTION OF THE DRAWINGS

Preferred embodiments of the present invention will now be described, by way of example only, with reference to the following drawings, in which:

FIG. 1 depicts a block diagram of a computing system, in accordance with an embodiment of the present invention;

FIG. 2 depicts a block diagram of certain components of a timeline image generator, in accordance with an embodiment of the present invention;

FIG. 3 is a flowchart depicting operational steps for predicting behavior patterns based on a generated timeline, in accordance with an embodiment of the present invention;

FIG. 4 is a flowchart depicting operational steps for identifying categorical variables, in accordance with an embodiment of the present invention;

FIG. 5 is a flowchart depicting operational steps for selecting one or more categorical variables as a key event marker, in accordance with an embodiment of the present invention;

FIG. 6 is a flowchart depicting operational steps for generating images associated with a timeline, in accordance with an embodiment of the present invention;

FIG. 7 is a flowchart depicting more detailed operational steps for predicting behavior patterns based on a generated timeline;

FIG. 8 is an example generated timeline with markers, in accordance with an embodiment of the present invention; and

FIG. 9 is a block diagram of an example system, in accordance with an embodiment of the present invention.

### DETAILED DESCRIPTION

Embodiments of the present invention recognize certain problems associated with feeding a variable transaction history through existing machine learning models. For example, existing models fail to discern external factors that can affect an action. As such, embodiments of the present invention provide solutions for predicting behavior pattern that accounts for external factors. For example, embodiments of the present invention provide a mechanism by which focal objects (e.g., users, customers, accounts, etc.) that each have a variable number of financial transactions (e.g., events) over a relevant time frame can be used in training. Embodiments of the present invention can then leverage this training to predict labeled behavior using supervised machine learning (e.g., deep learning). Embodiments of the present invention can predict labeled behavior by generating a visual timeline that incorporates external markers. Embodiments of the present invention can then feed the generated visual timelines into a supervised machine learning model (e.g., deep learning) with labeled behavior. Stated another way, embodiments of the present invention thereby provides an effective alternative for detecting behavior patterns in a series of transactions or events. This approach is deemed superior over other supervised machine learning mechanisms for many cases. Conversion of the transaction timeline into a graphic image also inherently resolves limitations that arise in typical numeric-based models. In addition, by coupling the graphic image with optional scaling (either local or global), the system is able to account for variable size transactions to better see the expression of behavior patterns. As discussed in greater detail later in this Specification, embodiments of the present invention can enhance full pattern detection capability.

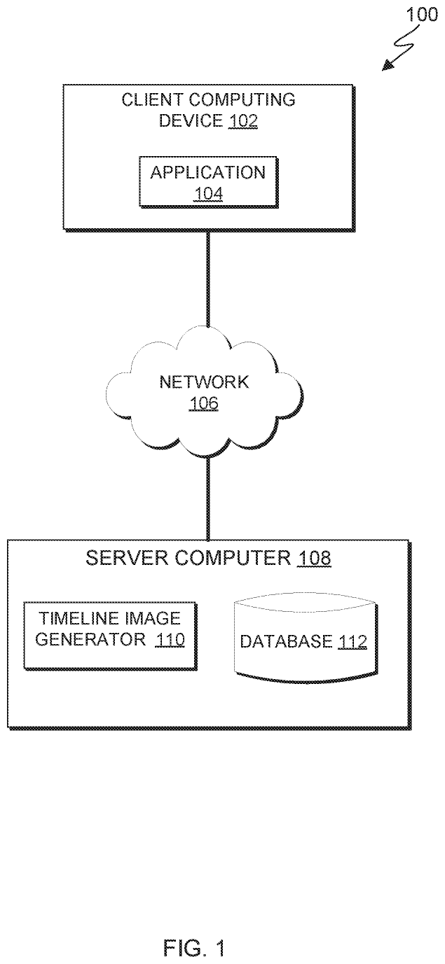

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

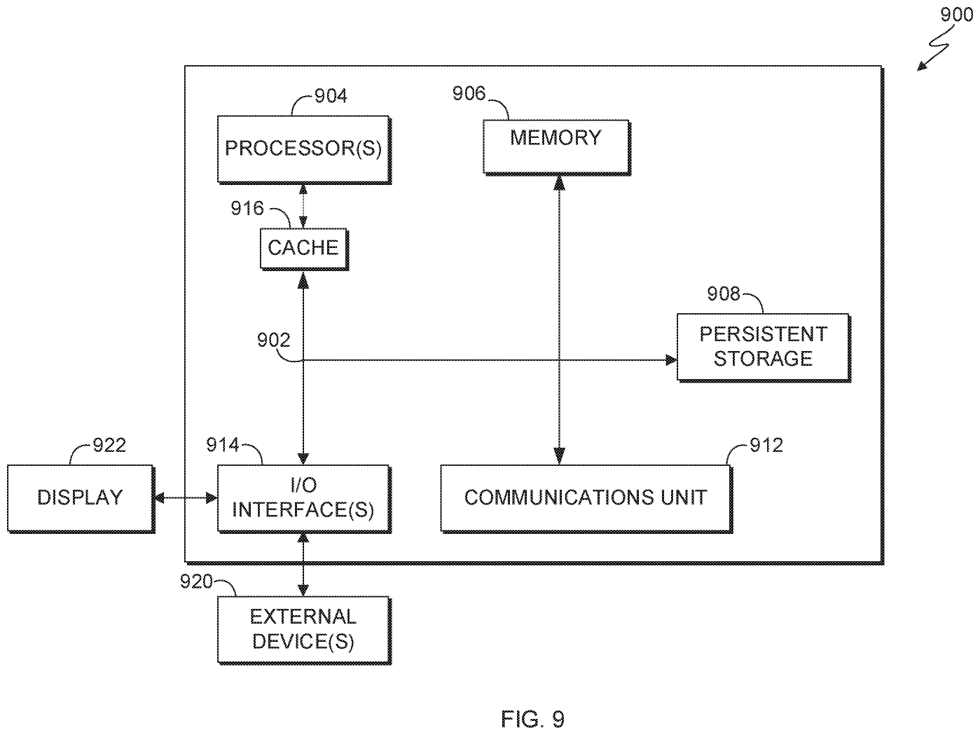

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 9.

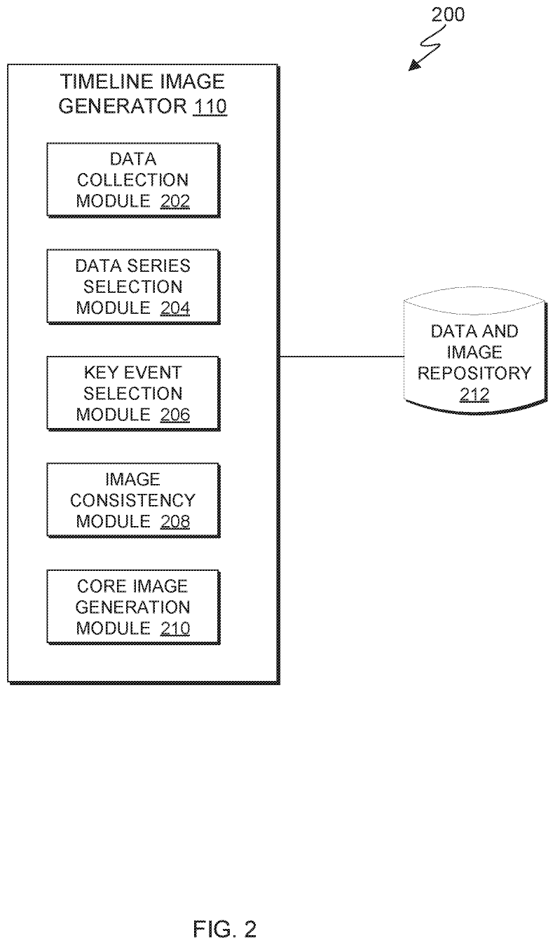

In this embodiment, client computing device 102 is a user device associated with a user and includes application 104. Application 104 communicates with server computer 108 to access timeline image generator 110 (e.g., using TCP/IP) to access user and database information. Application 104 can further communicate with timeline image generator 110 to transmit instructions to or transmit a request to generate a timeline with image markers and predict behavior patterns of respective users using the generated timeline, as discussed in greater detail with regard to FIGS. 2-8.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts timeline image generator 110 and database 112. In some embodiments server computer 108 can include a virtual database frame (not shown). In this embodiment, timeline image generator 110 resides on server computer 108. In other embodiments, timeline image generator 110 can have an instance of the program (not shown) stored locally on client computer device 102. In yet other embodiments, timeline image generator 110 can be stored on any number or computing devices.

In this embodiment, timeline image generator 110 generates a timeline with image markers and predict behavior patterns of target focal objects (e.g., respective users) using the generated timeline. In this embodiment, timeline image generator 110 recognizes that external factors (e.g., markers) can be public or private. As used herein, an external factor refers to any variable that can affect a user's decision to spend (e.g., invest, purchase, lease, etc.) or save money.

A public marker (e.g., factor) as used herein, refers to one or more factors that are viewable to and otherwise accessible to all members of a group. In some instances, a public marker can be applicable to an entire group of users. For example, public markers can include geographic (e.g., draught, flooding, heat, construction, etc.) factors and sociopolitical factors (e.g., infrastructure change, policies, etc.). Conversely, a private marker (e.g., factor) as used herein, refers to one or more factors unique to a respective user. For example, a private marker may include relationship status, changes in job history, changes in income, purchases made by a user, education, etc.

In this embodiment, timeline image generator 110 generates a timeline with image markers and subsequently uses the generated timeline to predict behavior patterns of target focal objects leveraging one or more components (not shown) such as a data collection module, a data series selection module, a key event selection module, an image consistency module, and a core image generation module as shown and described with respect to FIG. 2. In some embodiments, timeline image generator 110 may also include a deep learning machine learning module (also not shown).

Once the graphic image representing the timeline has been created, there are many ways to convert that image to an acceptable format as an input for the cognitive system that includes timeline image generator 110. For example, the image can be converted into a bitmap 72 having a grid of pixels 74. The resolution of the bitmap is a matter of system design, so it can vary depending upon the circumstances. The resolution can be based on the granularity of the timeline, e.g., the pixel size (width) being less than the smallest time increment as seen in the image. The bitmap then undergoes a procedure known as flattening. In that procedure, the grid is broken down into a series of rows or columns, and then those rows or columns are concatenated to form a one-dimensional array 76. In other words, if the bitmap is a grid of n by m pixels, then array 76 will be (n×m) in length, i.e., the first element of the array is pixel (1,1) and the last element in the array is pixel (n,m). Each element has a color value representing the color of that pixel, e.g., “w” equals white, “r” equals red, “bl” equals black, etc. The colors may correspond to a single integer value assigned by convention, or may be a combination of values such as a red/green/blue triad.

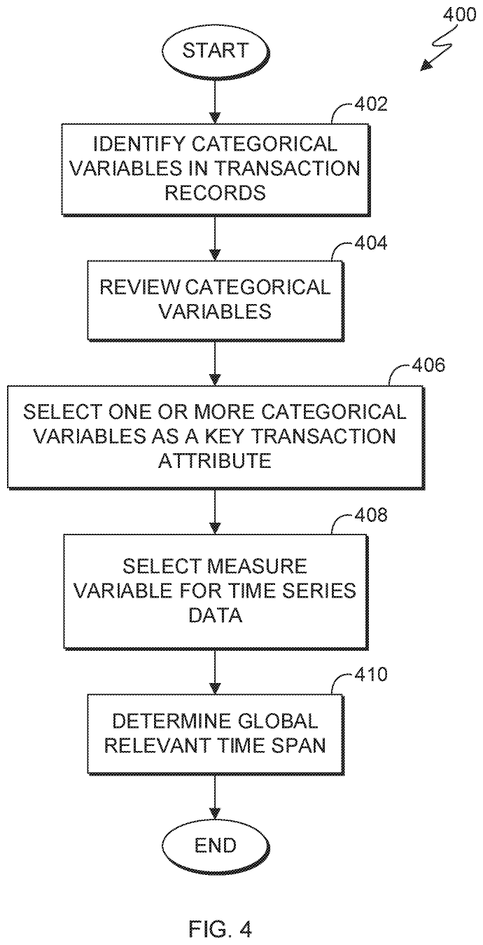

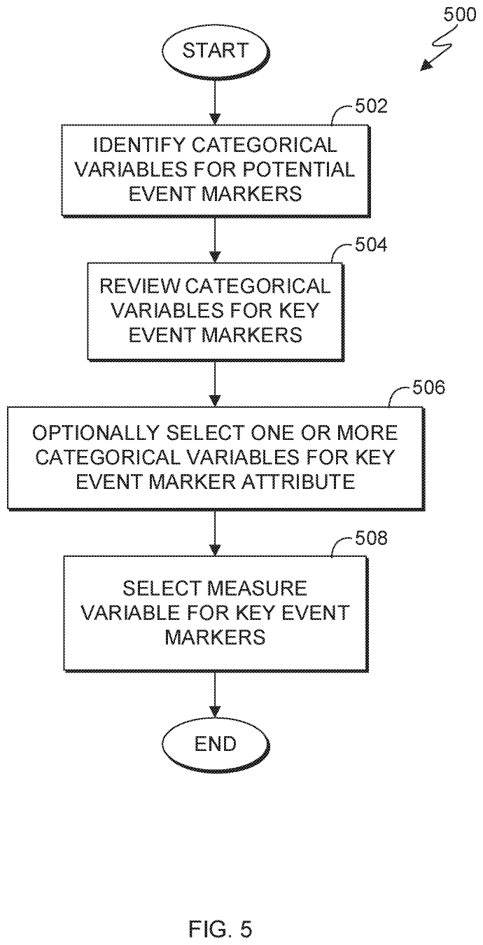

In this embodiment, timeline image generator 110 leverages each of these modules to generates a timeline with image markers and subsequently uses the generated timeline to predict behavior patterns of target focal objects by dynamically determining variables for potential event markers using the data series selection module and key event selection module as described in greater detail with respect to FIGS. 4 and 5.

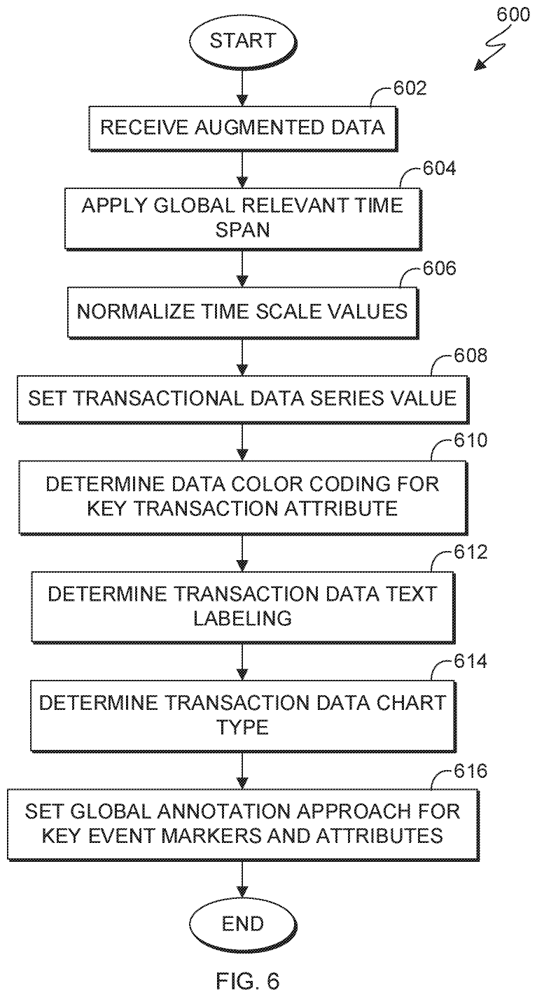

Timeline image generator 110 can then receive the augmented user data (e.g., the determined variables for potential event markers and leverage the image consistency module to generate one or more graphical icons (e.g., images) associated with each respective event for a given time period as described in greater detail with regard to FIG. 6. For example, timeline image generator 110 can determine a relevant time span, normalize time scale values, set transaction data series value to show positive and negative flows, determine data color coding for respective transactions, determine labels for each respective transaction, and generate annotations for the generated timeline.

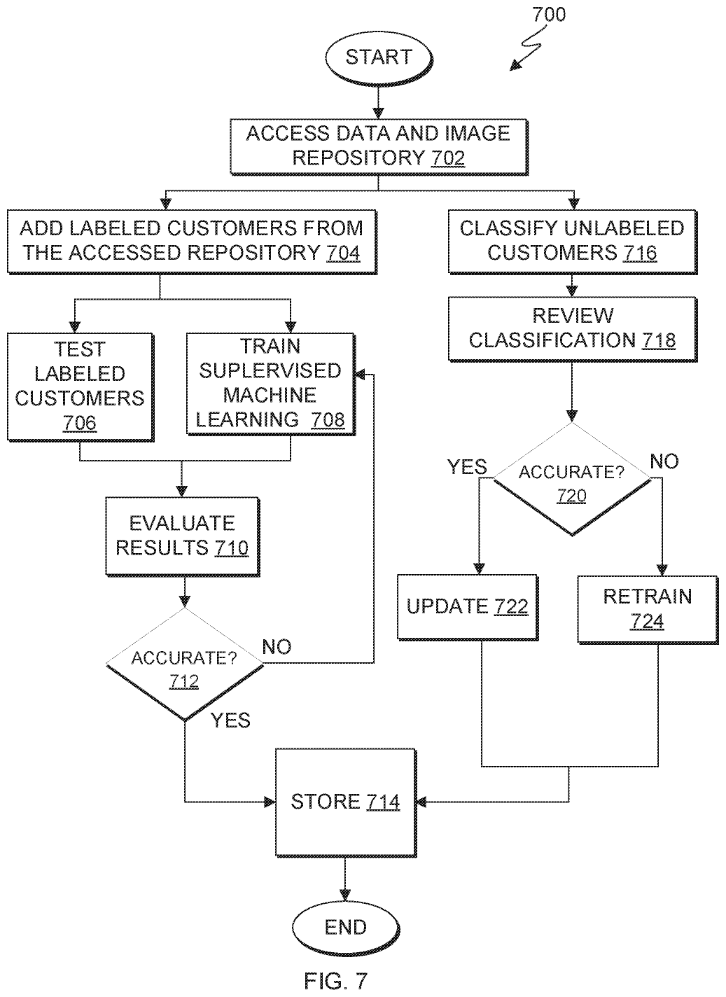

Timeline image generator 110 can then predict the behavior patterns of respective users using the generated timeline. In this embodiment, timeline image generator 110 can predict the behavior patterns of respective users by leveraging a deep learning supervised machine learning model as discussed in greater detail with respect to FIG. 7.

In this embodiment, timeline image generator 110 can take certain actions if the predicted behavior is unauthorized and/or otherwise flagged as suspicious or malicious behavior. For example, timeline image generator 110 can alert/flag of the transaction activity can be sent to a supervisor and take other actions. The actions could include, among other things, a notification (suspicious activity reporting), a denial of privileges (e.g., suspending a credit card account), or a challenge (e.g., sending a text message to a mobile electronic device associated with an owner of an account). Timeline image generator 110 could also provide a mechanism in the user interface to allow the supervisor or other system engineer to use the current graphic image with an assigned label for additional training, i.e., to update the cognitive system timeline image generator 110 is embedded within. The assigned label could be restricted to a list of known behavioral patterns or could be a new label if the supervisor is given appropriate system authority.

In this embodiment, database 112 functions as a repository for stored content. In this embodiment, content refers to training data (e.g., large machine learning datasets) as well as user specific data (e.g., accounts, financial history, employment history, etc.) In some embodiments, database 112 can function as a repository for one or more files containing user information. In this embodiment, timeline image generator 110 provides a mechanism to obtain user permission via an opt-in/opt-out feature. In certain circumstances, timeline image generator 110 can transmit a notification to a user each time that user information is accessed and/or otherwise used.

In this embodiment, database 112 is stored on server computer 108 however, database 112 can be stored on a combination of other computing devices (not shown) and/or one or more components of computing environment 100 (e.g., client computing device 102) and/or other databases that has given permission access to timeline image generator 110. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 depicts a block diagram of certain components of a timeline image generator, in accordance with an embodiment of the present invention.

Block diagram 200 shows components of timeline image generator 110 as well as a data and image repository accessed (e.g., data and image repository 212) by timeline image generator 110.

In this embodiment, timeline image generator 110 includes data collection module 202, data series selection module 204, key event selection module 206, image consistency module 208, and core image generation module 210.

Data collection module 202 collects information from data and image repository 212. In this embodiment, data and image repository 212 is functionally equivalent to database 112 and contains the information contained in database 112. For example, data and image repository 212 can contain user information that is either labelled (e.g., processed by timeline generator 110) or unlabeled (e.g., new users). Data and image repository 212 can include training data (e.g., large machine learning datasets that have been processed by timeline image generator 110) as well as user specific data (e.g., accounts, financial history, employment history, etc.).

Data series selection module 204 identifies categorical variables in transaction records of a user. In this embodiment, data series selection module 204 identifies categorical variables in transaction records and categorical variables for event markers. Both are variables that categorize the information into semi-homogeneous groups. The distinction between that the categorical variables for the transaction (discussed in greater detail with regard to FIG. 4) is based on the transaction itself. The transaction records will have types of transaction (e.g., cash, wire, check, etc.), country of transaction (USA, SPAIN, etc.), and a variety of other items like this that categorize aspects of the transaction. Categorical variables for event markers can refer to public external markers they are categories such as geographic, time-based makers (e.g., flooding at time and location of transaction, pandemic at time and location of transaction, etc.); sociopolitical markers (e.g., riots at time and location of transaction and political transitions at time and location of transaction, etc.) as well as private events, for example, variables can include life events (e.g., relationship status, job changes, purchases, educational achievements, financial status change, geographic variables, socio political variables, etc.).

Data series selection module 204 can then select one or more categorical variables for a respective transaction as a key transaction attribute. In this embodiment, a transaction is defined as either an influx or loss of monetary value (e.g., expenses, purchases, investments, savings, influx of money, etc.). A key transaction attribute is thus defined as metadata associated with the transaction that could be relevant to a user (e.g., as flagged or indicated by an expert). For example, key transaction attributes can include a type of transaction (e.g., cash, wire, check, etc.), country of transaction (e.g., USA, Spain, etc.). Extracted categorical variables for a transaction can also include time of day extracted from the transaction timestamp and grouped into categories of (e.g., morning, afternoon, evening and night). The geospatial data could be mapped to a risk table for that location of where the transaction occurred and extended to be classified as low, medium, high, very high. This last is a more generic and generally stored by the financial institution as part of their risk policies and not timed to the time of the transaction versus an external marker which would need a time element for inclusion in the context of embodiments of the present invention.

Optionally, data series selection module 204 can transmit the selected one or more categorical variables to another user for an expert review of categorical variables.

In this embodiment, data series selection module 204 can then select a measure variable for time series data. For example, data series selection module 204 can select an entire user's credit history as the measured variable. In this embodiment, the time series data is defined and shown as the X-axis as time. The Y-axis measures variable. For example, the stock price over time could be a time series data where the measure variable would be the stock price.

Data series selection module 204 can then determine a relevant time span. In this embodiment, data series selection module 204 can determine a historically relevant time span based on user defined requirements. In other embodiments, the relevant time span can be based on some combination of different factors such as data availability, the type of data analysis.

Key event selection module 206 identifies or otherwise selects a categorical variable such as an AML, alert type (e.g., structuring, flipping), etc.). Key event selection module 206 can then identify from the one or more selected categorical variables for a transaction, potential event markers that correlate with transactions and respective categorical variables of the transaction. For example, where a transaction is an influx of money, a categorical variable for the transaction could indicate it is a structured cash deposit.

Key event selection module 206 can then identify possible events that correlate to or otherwise explain the structured cash deposit by using a submodule such as a key event public selection module (not shown) and key event private selection module (not shown) For example, winning the lottery a few days before the structured cash deposit can be identified as a potential event. In this embodiment, key event selection module 206 can consider both public attribute (e.g., geographic weather event (flooding, fires, earthquakes, etc.) might be selected and annotated on the image with a related icon and private categorical variables such as life events (marriage, divorce, baby, etc.) might be selected and annotated on the image with a related icon.

In this embodiment, key event selection module 206 can leverage one or more machine learning methods to identify potential event markers. Optionally, key event selection module 206 can have an expert review of categorical variables for key event markers. In some other embodiments, prior to includes in the image generation module, an expert could review a candidate set of potential categorical markers and identify which they believed could be of most value in terms of finding behavior pattern similarities.

Image consistency module 208 resolves discrepancies in images and selects color coding and transaction data labeling. In other words, image consistency module 208 makes sure that when the images are generated for the machine learning/computer vision they have the required consistency. Since these generated images are being put in and trained against for behavioral labels its critical that they are all consistent in how they are represented. One example would be the transaction time. It must be normalized into a common base (e.g., using negative numbers of a timeline). If the time span or the representation of the time point itself are shown differently it will introduce issue in the models.

Core image generation module 210 generates images according to the color coding, text labeling, chart types selected by image consistency module 208. Core image generation module 210 generates the images as previously discussed for use in both training the model to find behavioral patterns as well. All the data needs to be converted from text-based information using the core Image generation model and applying the consistency module within this section.

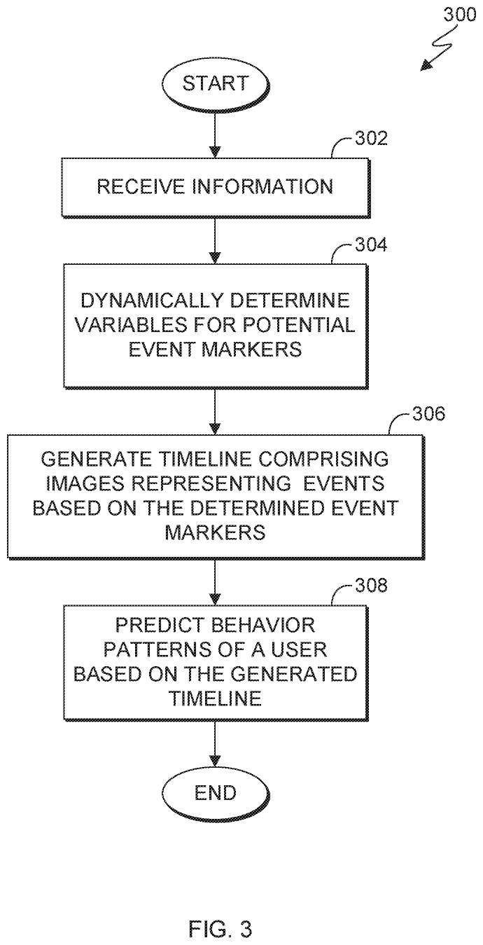

FIG. 3 is a flowchart 300 depicting operational steps for predicting behavior patterns based on a generated timeline, in accordance with an embodiment of the present invention.

In step 302, timeline image generator 110 receives a request. In this embodiment, timeline image generator 110 receives a request from client computing device 102. In other embodiments, timeline image generator 110 can receive a request from one or more other components of computing environment 100.

In this embodiment, a request can include a request to predict pattern behavior for a user. A request can also include information associated with a user (e.g., customer data). For example, timeline image generator 110 can receive unlabeled user information (e.g., accounts, financial history, employment history, transaction records, etc.).

In step 304, timeline image generator 110 dynamically determines variables for potential event markers using data series selection module 204 and key event selection module 206 as described in greater detail with respect to FIGS. 4 and 5. For example, timeline image generator 110 can identify categorical variables in transaction records, select one or more categorical variables as a key transaction attribute and subsequently select a respective key transaction attribute as an event marker.

In step 306, timeline image generator 110 generates a timeline comprising images representing events based on the determined event markers. In this embodiment, timeline image generator 110 generates a timeline comprising images representing events based on the determined event markers by determining a relevant time span, normalizing time scale values, setting transaction data series value to show positive and negative flows, determining data color coding for respective transactions, determining labels for each respective transaction, and generating annotations for the generated timeline as described in greater detail with respect to FIG. 6.

In step 308, timeline image generator 110 predicts behavior patterns of a user based on the generated timeline. In this embodiment, timeline image generator 110 predicts behavior patterns of a user utilizing one or more deep learning, supervised machine learning module as described in greater detail with respect to FIG. 7. In this embodiment, timeline image generator 110 predicts behavior patterns by training supervised machine learning modules on the generated timeline, evaluating results, and determining whether the results are accurate. In response to determining that the results are accurate, timeline image generator 110 stores the results in a repository. In response to determining that the results are not accurate, timeline image generator 110 iteratively retrains the supervised machine learning module until an accurate result is reached.

FIG. 4 is a flowchart 400 depicting operational steps for identifying categorical variables, in accordance with an embodiment of the present invention.

In step 402, timeline image generator 110 identifies categorical variables in transaction records. In this embodiment, timeline image generator 110 identifies categorical variables in transaction records received from a database (e.g., database 112). In some embodiments, timeline image generator 110 may receive transaction records along with a user request to generate a timeline with markers and predict behavior patterns of the user.

In this embodiment, timeline image generator 110 recognizes two categories: public or private. Within each category, timeline image generator 110 can leverage data series selection module 204 to identify variables affecting either public or private categories. For example, variables can include life events (e.g., relationship status, job changes, purchases, educational achievements, financial status change, geographic variables, socio political variables, etc.).

In step 404, timeline image generator 110 reviews categorical variables. In this embodiment, timeline image generator 110 can optionally transmit the identified categorical variables to a third party (e.g., a user) for review and verification. The third party may be an expert.

In step 406, timeline image generator 110 selects one or more categorical variables for a transaction as a key transaction attribute. In this embodiment, timeline image generator 110 selects one or more categorical variables for a transaction based on input received from experts. In other embodiments, timeline image generator 110 can select one or more categorical variables for a transaction as a key transaction attribute using one or more machine learning and artificial intelligence algorithms.

In step 408, timeline image generator 110 selects measure variable for time series data. In this embodiment, timeline image generator selects a measure variable for time series data. In this embodiment, the time series data sets time as the X-axis. In this embodiment, the Y-axis represents the measure variable. For example, stock price over time could be a time series data where the measure variable would be stock price.

In step 410, timeline image generator 110 determines a global relevant time span. In this embodiment, timeline image generator 110 determines a global relevant time span based on user requirements. In other embodiments, timeline image generator 110 can automatically determine a global relevant time span based on the type of analysis requested.

FIG. 5 is a flowchart 500 depicting operational steps for selecting one or more categorical variables as a key event marker, in accordance with an embodiment of the present invention.

In step 502, timeline image generator 110 identifies categorical variables in transaction records for potential event markers. In this embodiment, timeline generator 110 identifies categorical variables in transaction records for potential event markers by looking at transactions completed within a certain time period and identifying transactions meeting or exceeding a certain threshold for transactions. For example, where a transaction threshold is $100 (e.g., a categorical variable for a transaction), any transaction (e.g., spending, saving, investing, expenses, etc.) that meets or exceeds that threshold is flagged as potential event.

Timeline generator 110 can then correlate transactions with either public or private events by accessing user information (e.g., user financial accounts, social media accounts of the user, etc.) to further identify categorical variables for event markers to be placed or otherwise associated with the transaction. Categorical variables for event markers can refer to public external markers they are categories such as geographic, time-based makers (e.g., flooding at time and location of transaction, pandemic at time and location of transaction, etc.); sociopolitical markers (e.g., riots at time and location of transaction and political transitions at time and location of transaction, etc.)

In step 504, timeline image generator 110 reviews categorical variables for key event markers. In this embodiment, timeline image generator 110 optionally transmits its selected categorical variables for key event markers for review by an expert (e.g., a third party, given permissioned access by the user).

In step 506, timeline image generator 110 optionally selects one or more categorical variables for key event marker attributes. In this embodiment, timeline image generator 110 optionally provides a manual override for a user to specify a key event marker attribute.

In step 508, timeline image generator 110 selects measure variables for key event markers. For example, timeline image generator 110 can select an entire user's credit history as the measured variable. In this embodiment, a measure variable can include time series data is defined and shown as the X-axis as time. The Y-axis measures selected variables. For example, the stock price over time could be a time series data where the measure variable would be the stock price.

In this embodiment, timeline image generator 110 considers public and private data and iteratively performs step 502-508 for each public data and private data received.

FIG. 6 is a flowchart 600 depicting operational steps for generating images associated with a timeline, in accordance with an embodiment of the present invention.

In step 602, timeline image generator 110 receives augmented data. In this embodiment, timeline image generator 110 receives augmented data from data series selection module 204 and key selection module 206 (e.g., the results of flowchart 400 and 500, respectively). As used herein, augmented data (of the user) includes identified categorical variables, key transaction attributes based on identified categorical variables, measure variables relevant time span, and potential key event markers.

In step 604, timeline image generator 110 applies a global relevant time span. In this embodiment, timeline image generator 110 applies a global relevant time span received from data series selection module 204. For example, timeline image generator 110 can begin constructing a timeline based off of the global time span received from the data series selection module. In this example, the global relevant time span is ten years. Accordingly, timeline image generator 110 can apply a ten year time span as the maximum measure of a time when creating a timeline graph.

In step 606, timeline image generator 110 normalizes time scale values. In this embodiment, timeline image generator 110 normalizes time scale values by rescaling of the data from the original range so that all values are within a defined range.

In step 608, timeline image generator 110 sets transactional data series value. In this embodiment, timeline image generator 110 sets transaction data series value to show positive and negative transaction flows.

In step 610, timeline image generator 110 determines data color coding for key transaction attributes. In this embodiment, timeline image generator 110 determines data color coding for key transaction attributes by assigning a different color for a respective attribute based on the dollar amount associated with the transaction.

In step 612, timeline image generator 110 determines transaction data text labeling. In this embodiment, timeline image generator 110 determines transaction data text labeling by adding a respective label for each key attribute.

In step 614, timeline image generator 110 determines transaction data chart type. In this embodiment, timeline image generator 110 determines a chart type based on user requirements. In this embodiment, a chart type can be a bar graph, a line graph, etc.

In step 616, timeline image generator 110 sets global annotation approach for key event markers and attributes. In this embodiment, timeline image generator 110 sets a global annotation approach for key event markers and attributes.

FIG. 7 is a flowchart 700 depicting more detailed operational steps for predicting behavior patterns based on a generated timeline.

In step 702, timeline image generator 110 accesses a data and image repository. In this embodiment, timeline image generator 110 access a data and image repository containing user information and respectively associated transaction records. In this embodiment, timeline image generator 110 can access both labeled user information, that is, previously stored and labeled behavior and unlabeled user information.

In step 704, timeline image generator 110 adds labeled customers from the accessed repository. In this embodiment, timeline image generator 110 adds labeled customers from the accessed repository to other available, labeled customers. In this embodiment, a labeled customer denotes verified, ground truth information associated with the customer and is used as training or testing data for various machine learning and artificial intelligence algorithms of timeline image generator 110.

In step 706, timeline image generator 110 tests labeled customers. In this embodiment, timeline image generator 110 tests labeled customers using a deep learning, supervised machine learning model.

In step 708, timeline image generator 110 can train a supervised machine learning module. In this embodiment, timeline image generator can perform step 708 concurrently with step 706. In this embodiment, timeline image generator 110 can train a deep learning, supervised machine learning module with the generated timeline including event markers. In this way, timeline image generator 110 can capture necessary information in image and use the image as an input for machine learning. For example, the supervised machine learning modules could output a score that can be used to determine the similarity associated with certain groups.

In step 710, timeline image generator 110 evaluates results of either the tested labeled customers or the supervised machine learning module. In this embodiment, timeline image generator 110 evaluates the results by comparing the results to an accuracy threshold. In this embodiment, the accuracy threshold is set to 85% accuracy, that is 85% of the time, the machine learning model can discern a correct behavior pattern of a user. In other embodiments, the accuracy threshold can be configured to any desired threshold.

In step 712, timeline image generator 110 determines whether the evaluated results are accurate. In this embodiment, timeline image generator 110 determines that the evaluated results are not accurate if it the machine learning model fails to reach the accuracy threshold. Conversely, timeline image generator 110 determines that the evaluated results are accurate if the machine learning model reaches or exceeds the accuracy threshold.

If, in step 712, timeline image generator 110 determines that the evaluated results are accurate, then in step 714, timeline image generator 110 stores the results. In this embodiment, timeline image generator 110 stores the results in a data and image repository (e.g., database 112 or data and image repository 212).

If, in step 712, timeline image generator 110 determines that the evaluated results are not accurate, then processing reverts back to step 708 and iteratively repeats until accurate results are achieved.

In step 716, timeline image generator 110 classifies unlabeled customers. In this embodiment, step 716 can be performed concurrently with step 704. In this embodiment, where timeline image generator 110 access unlabeled customers, timeline image generator 110 classifies the unlabeled customers by using a supervised machine learning model.

In step 718, timeline image generator 110 reviews classification of unlabeled customers. In this embodiment, timeline image generator 110 can review classification of unlabeled customers by transmitting its classification for a manual review by an expert that has been given permissioned access.

In step 720, timeline image generator 110 determines whether the evaluated results are accurate. In this embodiment, timeline image generator 110 determines whether the evaluated results are accurate. In this embodiment, timeline image generator 110 determines that the evaluated results are not accurate if it the machine learning model fails to reach the accuracy threshold. Conversely, timeline image generator 110 determines that the evaluated results are accurate if the machine learning model reaches or exceeds the accuracy threshold.

If, in step 720, timeline image generator 110 determines that the evaluated results are accurate, then in step 722, timeline image generator 110 updates the classification of the record. Processing can then proceed to step 714 where timeline image generator 110 stores the updated transaction record into the data and image repository.

If, in step 720, timeline image generator 110 determines that the evaluated results are not accurate, then, in step 724, timeline image generator 110 retrains the supervised machine learning model. Processing can then proceed to step 714 where timeline image generator 110 stores the updated transaction record into the data and image repository.

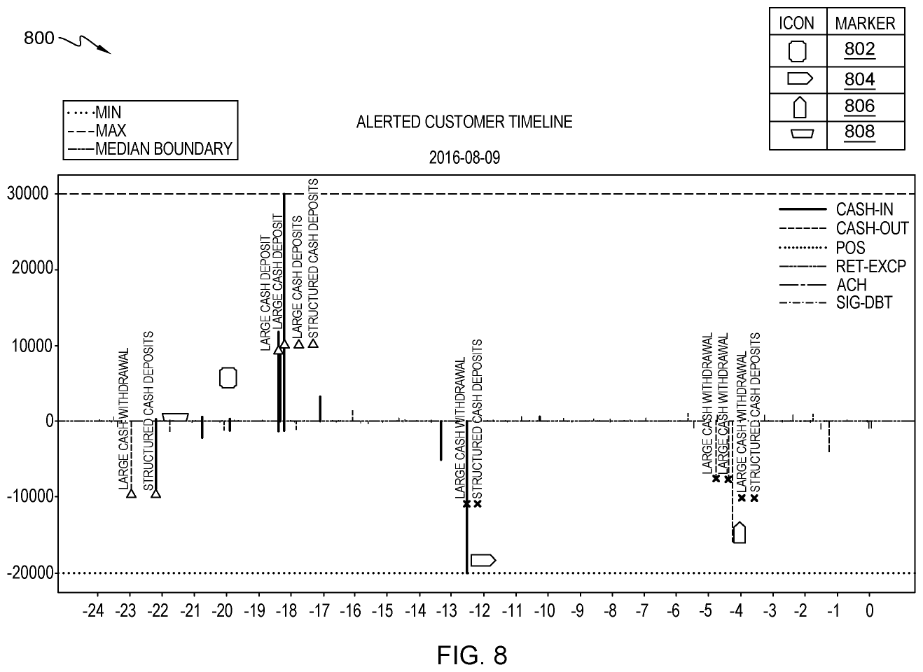

FIG. 8 is an example generated timeline with markers, in accordance with an embodiment of the present invention.

In this example, timeline image generator program 110 has generated timeline 800 for a respective user and added markers that denote factors that affected a user's financial decisions.

Each transaction is represented by a bar having a height that is proportional to the amount involved in the transaction (i.e., dollars) and having a particular color representing a transaction type for the transaction. In these bar charts, credits appear as positive values and debits appear as negative values but (due to the color coding) this is not necessary, i.e., a bar chart could show both credits and debits along the same direction. The bars are positioned according to the transaction dates, expressed here as the number of days that have passed since the transaction occurred. The scale of the time axis for these charts is weeks.

This example shows six types of transactions carried out by the first customer or other entity during the relevant time period. These are cash deposits (“cash in”), cash withdrawals (“cash out”), and point-of-sale transactions (“POS”), RET-EXCP transaction, and automated clearing house transfers (“ACH”), and signature debit card transactions (“debit”). Each transaction type is assigned its own color. Generated timeline 800 depicting a bar chart can have other graphic features relating to the transactions, in particular indications of statistical values associated with the timeline transactions such as a minimum transaction value, a maximum transaction value and a median transaction value. These values are represented as black patterned lines (solid, dashed, dotted) but they could alternatively be color-coded as well. They are just one more example of how numeric information could be converted into image representations for the cognitive analysis. The cognitive analysis may also rely on other (non-graphic) information for some implementations. This information may be in the form of various metadata associated with the timeline. For example, generated timeline 800 can include annotations for any of the transactions. In this example, annotations are “large cash withdrawal” (two instances), “large cash deposit” (three instances), “structured cash deposit” (one instance), and “structured cash deposit” (one instance). In this example, generated timeline 800 flags a large cash withdrawal and a structured cash deposit made in sequence as fraudulent.

In this example, timeline generator program 110 has added markers (e.g., graphical icons) 802, 804, 806, and 808. In this example, each of graphical icons 802, 804, 806, and 808 have different graphical icons denoting different factors. In this example, each of graphical icons 802, 804, 806, and 808 are all private markers added by timeline generator program 110.

Graphical icon 802 denotes an influx of income (e.g., a dollar amount less than $10,000 from the lottery). Graphical icon 804 denotes a purchase made by the user. In this example, timeline generator program 110 has noted a $20,000 purchase associated with the user buying a vehicle. Graphical icon 806 represents a potential expense and/or event. In this example, graphical 806 represents an anticipated house closing of the user. Graphical icon 808 represents an event also unique to the user, that is, graphical icon 808 denotes an education achievement (e.g., graduation).

FIG. 9 depicts a block diagram of components of computing systems within computing environment 100 of FIG. 1, in accordance with an embodiment of the present invention. It should be appreciated that FIG. 9 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 900 includes communications fabric 902, which provides communications between cache 916, memory 906, persistent storage 908, communications unit 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses or a crossbar switch.

Memory 906 and persistent storage 908 are computer readable storage media. In this embodiment, memory 906 includes random access memory (RAM). In general, memory 906 can include any suitable volatile or non-volatile computer readable storage media. Cache 916 is a fast memory that enhances the performance of computer processor(s) 904 by holding recently accessed data, and data near accessed data, from memory 806.

Timeline image generator 110 (not shown) may be stored in persistent storage 908 and in memory 906 for execution by one or more of the respective computer processors 904 via cache 916. In an embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. Timeline image generator 110 may be downloaded to persistent storage 908 through communications unit 912.

I/O interface(s) 914 allows for input and output of data with other devices that may be connected to client computing device and/or server computer. For example, I/O interface 914 may provide a connection to external devices 920 such as a keyboard, keypad, a touch screen, and/or some other suitable input device. External devices 920 can also include portable computer readable storage media such as, for example, thumb drives, portable optical or magnetic disks, and memory cards. Software and data used to practice embodiments of the present invention, e.g., timeline image generator 110, can be stored on such portable computer readable storage media and can be loaded onto persistent storage 908 via I/O interface(s) 914. I/O interface(s) 914 also connect to a display 922.

Display 922 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
in response to receiving a request, dynamically determining variables associated with a transaction;
generating a historical timeline for a respective target comprising images representing transactions affected by the dynamically determined variables; and
predicting behavioral patterns of the respective target based on the generated historical time.

2. The computer-implemented method of claim 1, wherein a transaction includes financial transactions.

3. The computer-implemented method of claim 1, wherein variables associated with a transaction include external events.

4. The computer-implemented method of claim 1, wherein an external event includes public and private events, wherein a private event includes social events of users associated with a respective transaction and wherein a public event includes events other than financial transactions via data sources other than financial transaction data sources.

5. The computer-implemented method of claim 1, wherein a respective target includes an account associated with a user.

6. The computer-implemented method of claim 1, wherein generating a historical timeline for a respective target comprising images representing transactions affected by the dynamically determined variables comprises:
generating a historical timeline that includes a plurality of transactions and images associated with each transaction of the plurality of transactions; and
augmenting the historical timeline with images associated with external events that affected each respective transaction.

7. The computer-implemented method of claim 1, wherein predicting behavioral patterns of the respective target based on the generated historical time comprises:
using the generated historical timeline and augmented timelines images to train a machine learning model to detect behavioral patterns.

8. A computer program product comprising:
one or more computer readable storage media and program instructions stored on the one or more computer readable storage media, the program instructions comprising:
program instructions to, in response to receiving a request, dynamically determine variables associated with a transaction;
program instructions to generate a historical timeline for a respective target comprising images representing transactions affected by the dynamically determined variables; and
program instructions to predict behavioral patterns of the respective target based on the generated historical time.

9. The computer program product of claim 8, wherein a transaction includes financial transactions.

10. The computer program product of claim 8, wherein variables associated with a transaction include external events.

11. The computer program product of claim 8, wherein an external event includes public and private events, wherein a private event includes social events of users associated with a respective transaction and wherein a public event includes events other than financial transactions via data sources other than financial transaction data sources.

12. The computer program product of claim 8, wherein a respective target includes an account associated with a user.

13. The computer program product of claim 8, wherein the program instructions to generate a historical timeline for a respective target comprising images representing transactions affected by the dynamically determined variables comprise:
program instructions to generate a historical timeline that includes a plurality of transactions and images associated with each transaction of the plurality of transactions; and
program instructions to augment the historical timeline with images associated with external events that affected each respective transaction.

14. The computer program product of claim 8, wherein the program instructions to predict behavioral patterns of the respective target based on the generated historical time comprise:
program instructions to use the generated historical timeline and augmented timelines images to train a machine learning model to detect behavioral patterns.

15. A computer system comprising:
one or more computer processors;
one or more computer readable storage media; and
program instructions stored on the one or more computer readable storage media for execution by at least one of the one or more computer processors, the program instructions comprising:
program instructions to, in response to receiving a request, dynamically determine variables associated with a transaction;
program instructions to generate a historical timeline for a respective target comprising images representing transactions affected by the dynamically determined variables; and
program instructions to predict behavioral patterns of the respective target based on the generated historical time.

16. The computer system of claim 15, wherein a transaction includes financial transactions.

17. The computer system of claim 15, wherein variables associated with a transaction include external events.

18. The computer system of claim 15, wherein an external event includes public and private events, wherein a private event includes social events of users associated with a respective transaction and wherein a public event includes events other than financial transactions via data sources other than financial transaction data sources.

19. The computer system of claim 15, wherein a respective target includes an account associated with a user.

20. The computer system of claim 15, wherein the program instructions to generate a historical timeline for a respective target comprising images representing transactions affected by the dynamically determined variables comprise:
program instructions to generate a historical timeline that includes a plurality of transactions and images associated with each transaction of the plurality of transactions; and
program instructions to augment the historical timeline with images associated with external events that affected each respective transaction.
